(19) United States
(12) Patent Application Publication
(10) Pub. No.: US 2004/0031104 A1
(43) Pub. Date: Feb. 19, 2004

(54) Can opener/organizer with spice rack and cutlery set features

(76) Inventors: Bruce Ancona, New York, NY (US); Robert A. Varakian, Edgewater, NJ (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/282,399

(22) Filed: Oct. 29, 2002

Related U.S. Application Data
(63) Continuation-in-part of application No. 10/075,746, filed on Feb. 14, 2002, now Pat. No. 6,470,521.
Application No. 10/075,746 is a continuation of application No. 09/836,626, filed on Apr. 17, 2001, now Pat. No. 6,374,443.

(51) Int. Cl. B25F 1/00

(52) U.S. Cl. 7/110

(57) ABSTRACT

A combination can opener and organizer includes components so that it functions as a can opener assembly and also may function as a spice rack or a cutlery set. In the combination, the container includes apertures that can receive spice bottles or, in a different design, cutlery items such as knives.

### RELATED APPLICATIONS

This application is a continuation-in-part of U.S. application Ser. No. 10/075,746, filed Feb. 14, 2002, which is a continuation of U.S. application Ser. No. 09/836,626, filed Apr. 17, 2001, now U.S. Pat. No. 6,374,443.

### FIELD OF THE INVENTION

The present invention relates generally to kitchen appliances and, more particularly, to a combination electric can opener and spice rack or can opener and organizer, such as a cutlery set, designed for ease of use and to provide the user with a number of advantageous features as set forth below.

### BACKGROUND OF THE INVENTION

Separately, can openers and so-called organizers for kitchen utensils and gadgets are well known. Can openers may be manually operated or automatic (for example, electric driven). Can openers also have been previously designed in a number of shapes and sizes.

Kitchen organizers also have been designed in a multitude of shapes and sizes. Kitchen organizers seek to organize and store typical kitchen utensils such as spatulas, wooden spoons, etc., in an efficient manner.

Both electric can openers and kitchen organizers are used in countless homes throughout the world. Unfortunately, these devices require critical countertop space. Thus, there is a need to provide devices that carry out the functions of can openers and kitchen organizers that, at the minimum, require substantially less space than would otherwise be needed.

Spice racks and cutlery sets are other types of kitchen items commonly used in countless homes. They are usually mounted on walls or placed on kitchen counters. As discussed below, spice racks and cutlery sets may be combined with other kitchen items in novel manners to provide various advantages and benefits to users.

### OBJECTS OF THE INVENTION

It is therefore an object of the present invention to provide a combined electric can opener and spice rack that provides various advantageous features over existing devices.

It is a further object of the present invention to provide a combined electric can opener and organizer that provides various advantageous features.

It as another object to provide a combined can opener and cutlery set that provides various advantageous features.

Various other objects, advantages and features of the present invention will become readily apparent to those of ordinary skill in the art, and the novel features will be particularly pointed out in the appended claims.

### SUMMARY OF THE INVENTION

In accordance with the present invention, a combination can opener and organizer includes a container, a can opener assembly disposed at or near a front surface of the container and adapted to open a can; and a cavity disposed within the container and open at the top that defines a storage compartment for one or more items.

As an aspect of the invention, the container is cylindrical in shape and the cavity is U-shaped and can hold a first item in its left-side portion and can hold a second item in its right-side portion.

In accordance with another embodiment of the present invention, a combination can opener and organizer includes a container with at least a front surface and first and second side portions, where at least one side portion includes one or more recesses that can hold a bottle or can, and a can opener assembly disposed at or near the front surface of the container.

As an aspect of the invention, the side portion includes plural recesses, each for holding a respective bottle.

As a further aspect of the invention, the recesses function as a spice rack.

As another aspect of the invention, the recesses extend along in a vertical direction.

As an additional aspect of the invention, recesses are disposed within both side portions of the container.

In accordance with a further embodiment of the present invention, a combination can opener and organizer includes a container, a can opener assembly, and plural cavities disposed within the container that define storage compartments for items.

As an aspect of this embodiment, the cavities are disposed in the top surface of the container.

As another aspect, the cavities are sized and shaped to be able to receive and hold cutlery items.

As an additional aspect, different cutlery items, including knives can be held, such that the container functions also as a cutlery set.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 is a schematic illustration of the combined can opener/organizer of the present invention;

FIG. 2 is another schematic illustration of the can opener/organizer from a rear perspective;

FIG. 3 is a further schematic illustration of the can opener/organizer from a top perspective;

FIG. 4 is a schematic illustration of another can opener/organizer combination of the present invention;

FIG. 5 is a schematic illustration of a can opener spice rack combination in accordance with the present invention; and

FIGS. 6A and 6B illustrate a can opener / cutlery set in accordance with the present invention.

### DETAILED DESCRIPTION OF THE INVENTION

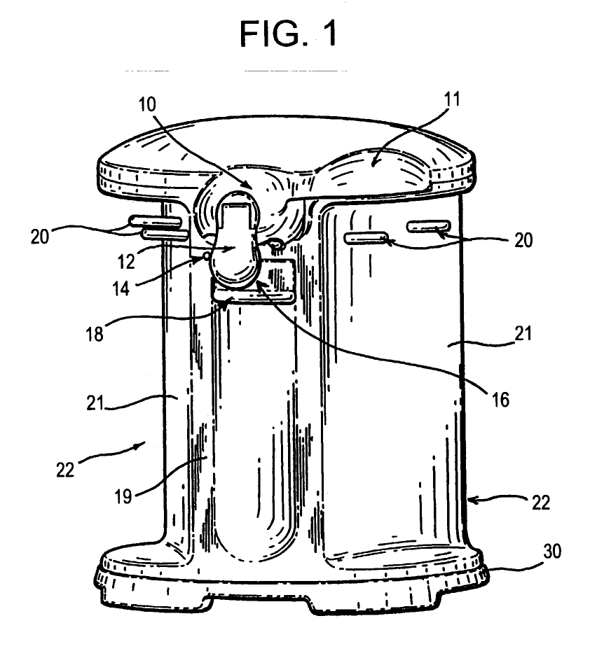

Referring now to the drawings, FIGS. 1-3 show various views of the can opener/organizer combination of the present invention. As shown in FIG. 1, the can opener/organizer, hereinafter “opener-organizer,” “opener-organizer combination,” “device” or the like, includes various features and elements pertinent to the device's electric can opener function and various features and elements pertinent to the organizer function. Elements pertaining to the can opener (for convenience, reference to can opener is intended to mean an electric can opener) function include at least a cutting lever 10, a handle 11 for the cutting lever, a magnet 12, a can guide 14, a geared wheel 16 and a bump 18. Elements pertaining to the organizer function include at least hooks 20, indentations or gadget areas 22, a storage compartment 24, and a divider 26, which is disposed within the storage compartment The can opener/organizer further includes a cord storage/lock 28, a top portion or component 29 and a base 30.

Although not shown, the opener-organizer of the present invention further includes various internal components necessary to operate the can opener function, including a motor and appropriate gearing for collectively driving the geared wheel. The opener-organizer includes a power cord (not shown) that extends from within the opener-organizer through the opening in the rear represented by cord storage/lock 28. Various particular internal designs and components used to operate an electric can opener are well known in the art and are not considered pertinent to the present invention. Thus, the internal structure and design of components internal to the opener-organizer of the present invention are not described herein except where necessary for an understanding of the present invention.

Referring again to FIG. 1, the opener-organizer is designed specifically to provide a single convenient and compact product that serves the functions of both an electric can opener and a kitchen organizer. As shown in FIG. 1, hooks 20 are provided along side surfaces (or walls) 21 disposed within the two gadget areas 22, which are disposed adjacent to the front surface 19 of the opener-organizer at about 45 degree angles thereof. The front surface 19 of the opener-organizer is utilized for opening a can which is placed adjacent to the front surface and the top of the can is urged upwards so that the can's rim is placed under geared wheel 16 in a manner well known in the art. The can then is opened in a manner well known in the art, that is, the cutting lever's handle 11 is depressed which causes the internal motor to turn geared wheel 16 thus cutting the can's lid. Magnet 12 swivels and operates to hold the lid once cut from the can.

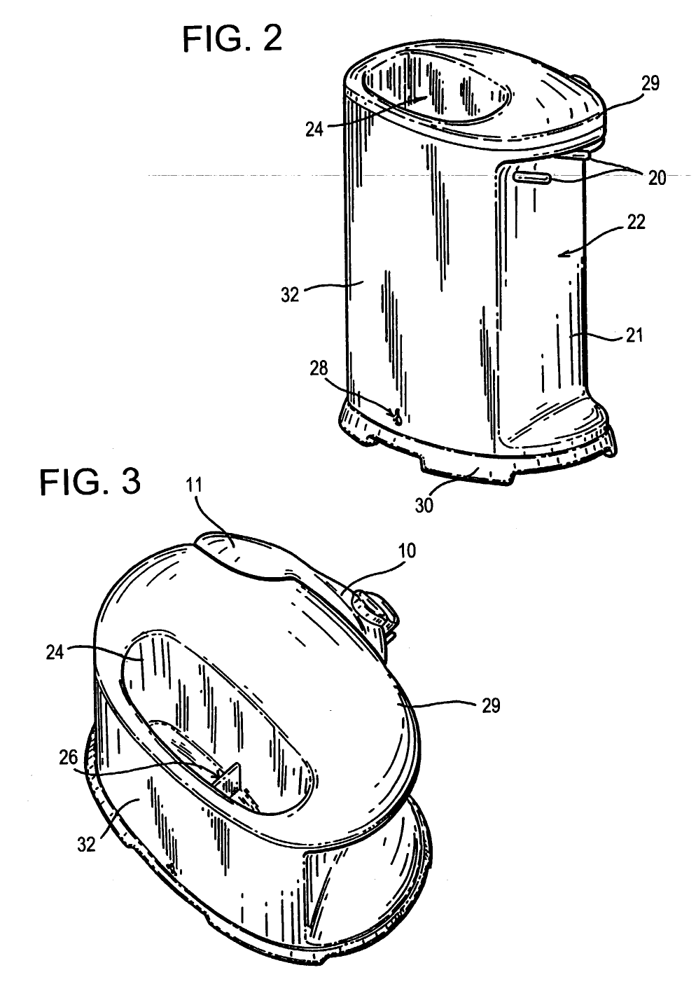

In accordance with the present invention, the particular size and dimensions of the various components of the can opener function of the device are appreciated to be relatively small to allow nearby space and surfaces to be utilized for storage of kitchen utensils and other gadgets. The utilization of such space is quite different and not contemplated in prior art devices, whereby spaces and surfaces adjacent to and alongside the front surface of a can opener is un-utilized. The present invention however maximizes such space by providing two appropriately sized gadget areas 22, as best shown in FIGS. 1 and 2. Two hooks 20 are disposed near the top of each of the gadget areas 22 and operate to hold typical kitchen gadgets and utensils, such as a peeler, a measuring spoon, etc. Moreover, the opener-organizer is of sufficient height to accommodate typical cans to be opened and such height of the device allows for gadget areas 22 likewise to be of sufficient height to accommodate many typical kitchen utensils. Still further, while the drawings show an opener-organizer having four hooks, two in each gadget area, any appropriate number of hooks (e.g., three) may be provided in each gadget area and the positions of those hooks within the gadget areas may differ from that shown. Also, the shapes of the hooks may be different. For example, some or all of the hooks may be looped in shape so that utensils and gadgets being held do not fall of the hooks in the event the opener-organizer is moved. Still further, looped hooks allow for the storage of more delicate items in the storage areas, such as tea cups and the like.

Referring to FIGS. 2 and 3, which best show the rear of the opener-organizer of the present invention, a storage compartment 24 is disposed in the rear of the device and may be used to store a variety of kitchen tools, utensils or appliances. For example, long wooden spoons, spatulas or other such items may be stored in compartment 24. In accordance with the present invention, storage compartment 24 is disposed within an electric device at a position that generally is not utilized in prior art designs (i.e., existing electric can openers). In the present invention, the various internal mechanisms, including the motor, are installed near the front of the opener-organizer. The rear of the opener-organizer, otherwise un-utilized, is provided to include storage compartment 24 thus maximizing the utilization of space for storage of kitchen items. Moreover, storage compartment 24 is relatively deep and extends from the top surface 29 almost to base 30, leaving a small amount of space in the base for the power cord.

In accordance with the present invention, the height of the opener-organizer is designed relatively tall to accommodate relatively tall cans to be opened and, likewise, storage compartment 24 is provided equally tall (i.e., deep) to accommodate relatively long utensils. Further, storage compartment 24 is provided with a divider 26 which functions to keep tools and utensils within the compartment erect. Additional dividers can be included as appropriate.

FIG. 2 shows cord storage/lock 28, which is an aperture disposed near the bottom of the rear surface 32 of the opener-organizer. A storage space (not shown) is disposed within the opener-organizer and immediately in front of cord storage/lock 28 for stowing away the device's electrical power cord (also not shown). Cord storage/lock 28 is shaped to include a generally round portion through which the can slide and a relatively narrow, flat portion that functions as the lock when the power cord is forced into this flat portion of cord storage/lock 28.

As previously discussed, the can opener feature of the present invention opens a can by using the various components shown in FIG. 1. Such a can be opened without holding the can in place and without the need to hold down cutting lever 10, or its handle 11, while the can is being cut. As previously mentioned, magnet 12 is designed to hold up the lid upon completion of cutting. Moreover, magnet 12 also is designed to flip up to enable the user to check the positioning of the can within the device, can guide 14 assists the user to correctly position the can, and bump 18 maintains the can in an upright position for easy cutting.

As best shown in FIG. 3, both top 29 and base 30 of the opener-organizer are oval in shape, and top 29 has a rounded top surface. Top 20 and base 30 extend past side walls 21 thus defining the two gadget areas 22. Preferably, all of the hooks 20 extending from the side walls 21 do not extend beyond the top and base. Rear surface 32 is curved and follows the contour of the oval-shape of the top and base. The two side walls 21 extend from the front surface 19 (see FIG. 1) at an angle within the range of 30 to 60 degrees, or perhaps even beyond this range, to provide suitably sized gadget areas 22 and, at the same time, to allow sufficient space between the side walls at the rear of the opener-organizer to provide a sufficiently sized storage compartment 24. With the design shown, an oval-shaped device is provided that includes a can opener on its front surface, two gadget areas 22 along the two sides sufficient to store utensils and gadgets, and a deep storage area 24 sufficiently sized to store long utensils, all within a single device.

As also shown in FIG. 3, handle 11 of the cutting lever 10 is designed to have a large format for ease of use and designed to follow the contour of the oval shape of top 29, and further follows the contour of the curved top surface of top 29. Thus, even with various elements that carry out the can opener function of the invention, the opener-organizer of the present invention is reasonably sized and oval in shape, in accordance with the present embodiment. Of course, other sizes and shapes are possible, including round, rectangular, square, triangular, hexagonal, etc. Finally, base 30 includes four feet to provide stability to the opener-organizer, with silicon rubber pads or the like disposed on the feet for anti-slip performance.

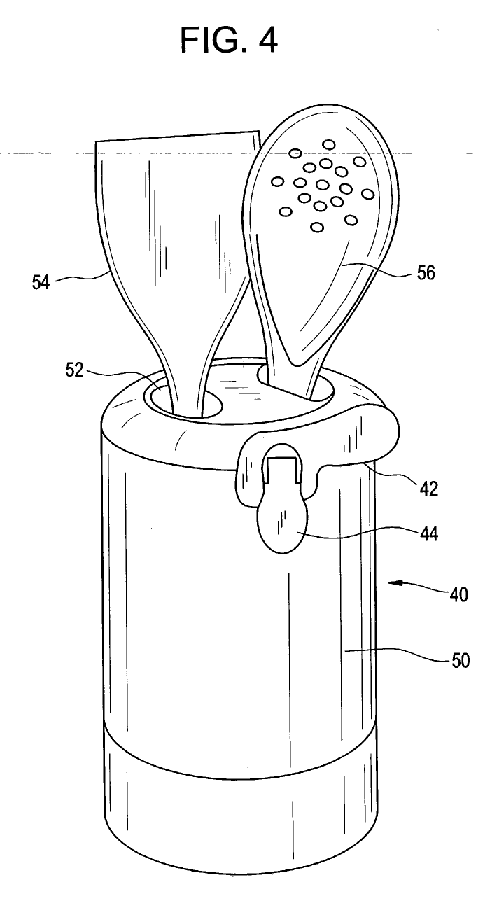

FIG. 4 is a schematic illustration of another can opener/organizer combination 40 (“opener-organizer”) of the present invention. While opener-organizer 40 shown in FIG. 4 is different from the version shown in FIGS. 1-3, it operates in a similar fashion. Opener-organizer 40 includes components pertinent to its can opening function, including handle 42 and magnet/can guide 44. Other typical features of the can opener are not shown, and since such other features (including internal components) are well known, further discussion thereof is omitted herein.

Opener-organizer 40 includes a body 50, which is cylindrical in shape. Of course, the body of the opener-organizer may have a different shape. Body 50 includes a cavity 52 in which utensils may be stored. Cavity 52 is shown to be U-shaped, with left and right portions for holding plural utensils as shown. Other shapes are possible. For illustrative purposes, utensils 54 and 56 are shown disposed within and stored in cavity 52. Of course, many other types of utensils may be stored within the cavity.

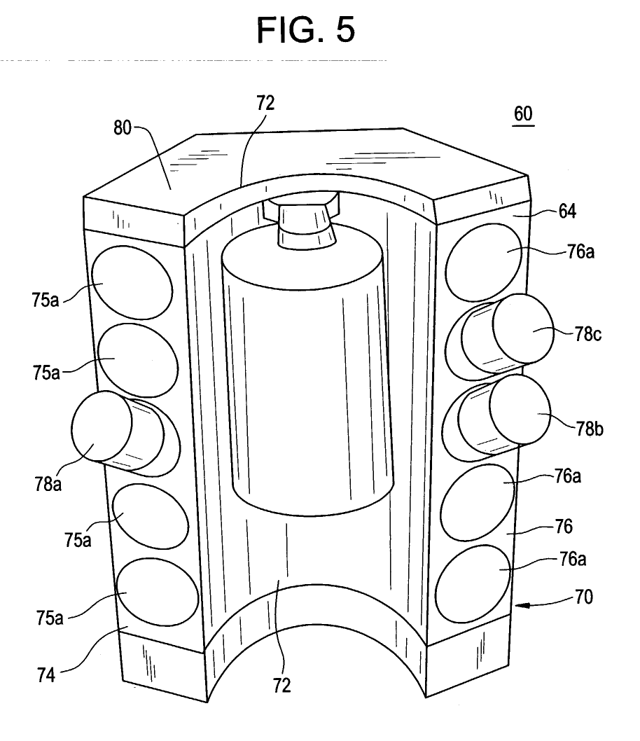

FIG. 5 is a schematic illustration of a can opener/organizer where the organizer functions as a spice rack in accordance with the present invention. For convenience, the design of FIG. 5 is referred to as can opener spice rack 60. The can opener spice rack 60 includes a can opener similar to the can opener in the previously discussed designs. Moreover, can opener spice rack 60 includes a body which functions as a spice rack, as further discussed below.

Can opener spice rack 60 includes various components for carrying out its can opener function, including handle 62 and magnet/can guide 64, as well as other components that are well known in the art. Can opener spice rack 60 includes a body 70 in which the can opener components are disposed. As shown in FIG. 5, body 70 includes a round recessed surface 72 that defines an interior portion in which a can to be opened may be placed. Body 70 further includes protruding left and right side portions 74 and 76 that, as will discussed, accommodate the spice rack component of the combination of the present invention. Specifically, the left portion 74 of body 70 includes a number of recesses 75a (5 shown in the exemplary design) and right portion 76 also includes a number of recesses 76a, all to accommodate spice bottles or the like. In the exemplary design shown, 10 bottles or containers can be stored within the recesses (three bottles 78a, 78b and 78c shown for illustrative purposes). In the version shown, the recesses within left side portion 74, as well as the recesses within right side portion 76, extend along in a vertical direction and every recess is disposed adjacent to the interior portion (adjacent surface 72) in which a can to be opened may be placed.

In accordance with the present invention, Can opener spice rack 60 can be utilized to open cans in a manner well known in the art, where such cans are disposed within the interior portion of body 70, which in the exemplary design has somewhat of a U-shaped appearance. In addition, can opener spice rack 60 includes storage space that functions as a spice rack, and in the specific design shown, a spice rack with left and right sections that are disposed on opposite sides of the can opener feature.

It should be appreciate that the design shown in FIG. 5 may be easily modified to provide for storage of a different number of bottles or containers and, of course, bottles or containers storing items other than spices may be accommodated. Still further, each and any of the storage recesses 75a, 76a may be used to accommodate other items other than bottles or containers, such as silverware, spatulas or other kitchen utensils, or even pencils, folded paper, and other items. Moreover, the can opener spice rack of the present may include storage recesses in its top surface 80 (e.g., see FIGS. 3 and 4), as well a storage openings in its rear surface. Still further, the present invention shows left and right body portions 74 and 76 extending outward from a central portion 82 (adjacent surface 72) in opposite directions at a particular angle, but these body portions which define the spice rack feature of the invention may extend outwards at different angles. For example, the body may be strictly U-shaped where left and right portions extend outwardly from the base at right angles thereof (i.e., extend outward so that they are parallel to one another). As another example, the spice rack left and right portions may extend outward at different angles. For example, the left body portion extends at a right angle to the base and the right body portion extends outward at a 45 degree angle relative to the base's central portion. Still further, the spice rack openings may be disposed in the rear of the can opener spice rack of the present invention, or some may be in the rear or side, with others disposed at the front.

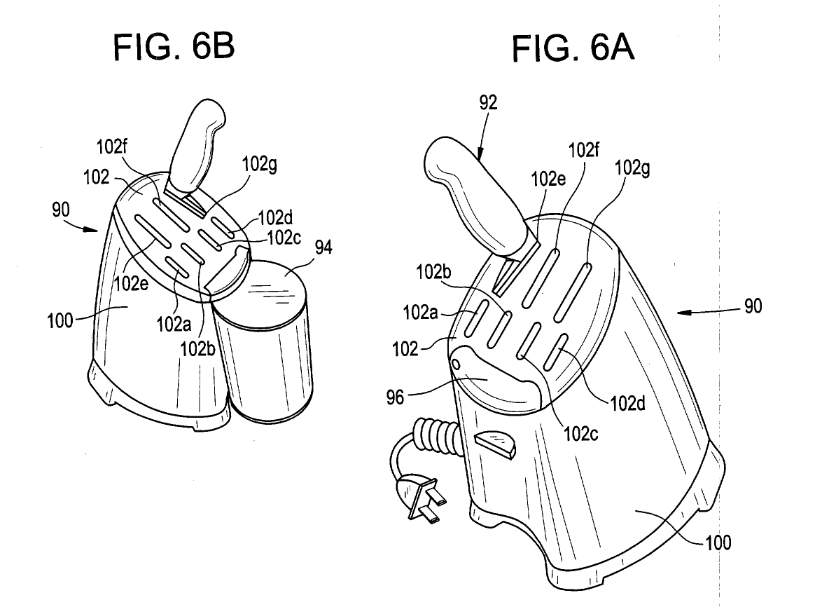

FIGS. 6A and 6B illustrate a can opener/organizer where the organizer functions as a cutlery set in accordance with the present invention. For convenience, the can opener/organizer shown is FIGS. 6A and 6B is referred to as can opener/cutlery set 90. FIG. 6A illustrates the can opener/cutlery set 90 with a knife 92 shown stored within a storage opening, and FIG. 6B illustrate the can opener/cutlery set 90 with a knife shown stored and also with a can 94 shown being opened by the can opener feature of the present invention.

Referring to FIG. 6A, the can opener/cutlery set 90 includes components for the can opener function, similar to the components discussed in the previously discussed designs. Since the can opener features have been previously discussed and are well known, further discussion is not provided, except that can opener/cutlery set 90 is shown to include a handle 96 that is shaped somewhat different from the handles previously discussed. Handle 96 is depressed to operate the can opening feature of the present invention. Of course, handle 96 may have other shapes and designs that are well known in the art.

The can opener/cutlery set 90 shown in FIGS. 6A and 6B includes a body 100. Body 100 includes sufficient internal storage for internal components (not shown in the drawings) of the can opener feature. Moreover, top surface 102 of body 100 includes plural openings 102a, 102b, 102c, 102d, 102e, 102f and 102g in which knives of various sizes may be stored. Thus, body 100 with top surface 102 has plural openings as shown operates as a cutlery storage device for storing knives of various sizes. Of course, the number of openings may be different than that shown in the exemplary design. Moreover, the openings may be of different shapes and sizes to accommodate other types of cutlery items, including any cutlery item that may stored within typical, prior art cutlery sets. Top surface 102 may have a shape different than that shown, such as rectangular or hexagonal, or other shape. The number, size and placement of the openings within the top surface, used to store cutlery, also may be different. Still further, the openings, i.e., the cutlery set, may be disposed within other surfaces, such as a side surface or rear surface, or on multiple surfaces, where openings for cutlery are placed on multiple side surfaces, or on the top and one (or two) side surfaces, etc. The can opener/cutlery set shown in FIGS. 6A and 6B is circular, and reference to side, rear surfaces, etc., refers to respective portions of the side surface (since a round item only has a single side surface). Of course, it may be square or other shape and thus references to front, rear, side is clearer. In any event, the present invention is not limited to exact placement of the apertures for cutlery as that shown in the drawings.

While the present invention has been particularly shown and described in conjunction with various embodiments thereof, it will be readily appreciated by those of ordinary skill in the art that various changes may be made without departing from the spirit and scope of the invention. For example, although the present discussion is directed to a can opener/organizer, can opener/spice rack and can opener/cutlery set, all generally for kitchen use, the present invention is not limited solely for use in the kitchen and may be widely applied to other areas of use where cans may need to be opened.

Therefore, it is intended that the appended claims be interpreted as including the embodiments described herein, the alternatives mentioned above, and all equivalents thereto.

What is claimed is:

1. A combination can opener and organizer, comprising:
a container;
a can opener assembly disposed at or near a front surface of the container and adapted to open a can; and
a cavity disposed within the container and open at the top for defining a storage compartment for one or more items.

2. The combination of claim 1, wherein the container is cylindrical in shape.

3. The combination of claim 1, wherein the cavity is U-shaped and adapted to hold a first item in a left-side portion of the U-shaped cavity and adapted to hold a second item in a right-side portion of the U-shaped cavity.

4. A combination can opener and organizer, comprising:
a container having at least a front surface and first and second side portions, at least one of the first and second side portions including at least one recess adapted to receive and hold a bottle; and
a can opener assembly disposed at or near the front surface of the container and adapted to open a can.

5. The combination of claim 4, wherein said at least one of the first and second side portions includes a plurality of recesses, each of the recesses adapted to receive and hold a respective bottle.

6. The combination of claim 5, wherein said at least one of the first and second side portions including the plurality of recesses is adapted to function as a spice rack to hold a plurality of bottles containing spices.

7. The combination of claim 5, wherein the recesses extend along said at least one of the first and second side portions in a vertical direction so that each of the recesses is disposed adjacent to a position in which a can may be disposed during use of the can opener assembly.

8. The combination of claim 4, wherein the other of said at least one of the first and second side portions includes at least one recess adapted to receive and hold a bottle.

9. The combination of claim 4, wherein each of the first and second side portions includes a respective plurality of recesses, each of the recesses adapted to receive and hold a respective bottle.

10. The combination of claim 9, wherein the recesses within the first side portion are disposed within the first side portion in a vertical direction and the recesses within the second side portion are disposed within the second side portion also in the vertical direction.

11. The combination of claim 10, wherein all of the recesses within both the first and second side portions are disposed adjacent to a position in which a can may be disposed during use of the can opener assembly.

12. A combination can opener and organizer, comprising:
a container;
a can opener assembly disposed at or near a front surface of the container and adapted to open a can; and
a plurality of cavities disposed within the container for defining storage compartments for items.

13. The combination of claim 12, wherein the plurality of cavities are disposed in a top surface of the container.

14. The combination of claim 12, wherein the plurality of cavities are sized and shaped to be adapted to receive and hold cutlery items.

15. The combination of claim 12, wherein each of the plurality of cavities is sized and shaped to receive and hold a respectively different cutlery item.

16. The combination of claim 12, wherein the plurality of cavities are disposed in a top surface of the container and each of the plurality of cavities is sized and shaped to receive and hold a respectively different type of knife.

17. The combination of claim 12, wherein each of the plurality of cavities is sized and shaped to receive and hold a respective knife with each of the knives being held in alignment in relation to one another.

18. The combination of claim 12, wherein each of the plurality of cavities within the container is adapted to function as a cutlery set for holding cutlery items.
